(19) United States
(12) Patent Application Publication
(10) Pub. No.: US 2007/0200656 A1
(43) Pub. Date: Aug. 30, 2007

(54) TWO WAY COMPOSITE NITINOL ACTUATOR

(75) Inventor: Steven Walak, Natick, MA (US)

Correspondence Address: KENYON & KENYON LLP, 1500 K STREET N.W., SUITE 700, WASHINGTON, DC, 20005, US

(73) Assignee: BOSTON SCIENTIFIC SCIMED, INC., MAPLE GROVE, MN (US)

(21) Appl. No.: 11/742,966

(22) Filed: May 1, 2007

Related U.S. Application Data
(62) Division of application No. 10/701,456, filed on Nov. 6, 2003.

(51) Int. Cl. H01H 37/52

(52) U.S. Cl. 337/333

(57) ABSTRACT

A two-way actuated shape memory composite material is provided. The composite material includes a shape memory alloy and an elastic metal. The composite material takes a first shape at a lower temperature and a second shape at a higher temperature. At the higher temperature, the shape memory alloy has a “remembered” shape, causing the composite material to take the second shape. The elastic material provides the composite material with elastic properties which cause the composite material to return to the first shape when cooled to the lower temperature.

### FIELD OF THE INVENTION

The present invention relates to two-way actuators. Specifically, the present invention relates to two-way thermal actuators comprising a shape memory alloy, such as nitinol.

### BACKGROUND OF THE INVENTION

Shape memory alloys (SMA) are alloys that exhibit the ability to return to a specific shape when brought to a certain temperature. Materials that exhibit shape memory thus have the ability to “remember” and return to a specified shape.

Nitinol, a class of nickel-titanium alloys, is well known for its shape memory properties. As a shape memory material, nitinol is able to undergo a reversible thermoelastic transformation between certain metallurgical phases. Generally, the thermoelastic shape memory effect allows the alloy to be shaped into a first configuration while in the relative high-temperature austenite phase, cooled below a transition temperature or temperature range at which the austenite transforms to the relative low-temperature martensite phase, and deformed while in the martensitic state into a second configuration. When heated, the material returns to austenite such that the alloy transforms in shape from the second configuration to the first configuration. The thermoelastic effect is often expressed in terms of the following transition temperatures: Mₛ, the temperature at which austenite begins to transform to martensite upon cooling; M_{f}, the temperature at which the transformation from austenite to martensite is complete; Aₛ, the temperature at which martensite begins to transform to austenite upon heating; and A_{f}, the temperature at which the transformation from martensite to austenite is complete.

Two-way actuation using SMAs is currently achieved in one of two ways. As an example of the first way, a single shape memory alloy is coupled to an elastic bias spring, as shown in FIGS. 1A and 1B. In FIG. 1A, at a lower temperature, which is equal to or less than M_{f}, the nitinol spring 10 is compressed by the elastic spring 20. As the temperature is raised to a temperature equal to or greater than Aₛ, the nitinol spring 10 starts to expand. In FIG. 11B, at a higher temperature, which is equal to or greater than A_{f}, the nitinol spring 10 takes on the shape as illustrated, compressing the elastic spring 20. If the temperature is then lowered to a temperature equal to or less than Mₛ, the nitinol spring 10 starts to compress. When the temperature lowers so that it is again equal to or less than M_{f}, the nitinol spring 10 is again fully compressed by the elastic spring 20, as shown in FIG. 1A.

In both FIGS. 1A and 1B, the combined spring assembly needs to be constrained by a rigid constraint 50. Rigid constraint 50 has two ends for affixing to opposite ends of the spring assembly as well as a side support to prevent lateral movement of the spring assembly that would otherwise occur due to compression of the spring assembly between the two end constraints. One problem with this arrangement is the size of the assembly, which due to the necessity of constraining the two springs, may only be scaled down to a limited degree.

The second way of achieving two-way actuation is to laboriously train a SMA material. However, this training may require on average as many as twenty (20) heating, cooling, and constraint cycles. Therefore, since the processing is difficult and has yet to be fully perfected, limited commercial application has been-found for this type of two-way actuation.

SMA materials and specifically nitinol have been applied to numerous applications. For example, nitinol has been used for applications such as fasteners, couplings, heat engines, and various dental and medical devices. Owing to the unique mechanical properties of nitinol and its biocompatibility, the number of uses for this material in the medical field has increased dramatically in recent years and would increase further if an easier way of forming a two-way actuated SMA can be found.

### SUMMARY OF THE INVENTION

If a better way to form a two-way actuated SMA can be found, the possible uses are infinite. For example, any application that requires an actuated device may use a two-way actuated SMA. The present invention provides a two-way actuated composite material, which may be used in numerous actuator systems. In one embodiment of the present invention, a two-way actuated composite material is provided. The composite material comprises a first component comprising a first shape memory alloy, and a second component, which may be selected from the group consisting of a second shape memory alloy, stainless steel, cobalt alloy, refractory metal or alloy, precious metal, titanium alloy, nickel superalloy, and combinations thereof, where the composite material forms a first shape at a temperature equal to or above A_{f} of the first component and the composite material forms a second shape at a temperature equal to or below M_{f} of the first component. The first component and second component may be fabricated together to form a metallurgical bond between them by working and/or heating. The second component is elastically deformable, and, during use of the actuator, the second component is elastically deformed between the second shape and the first shape. The two-way actuator may be constructed so that the elastic limit of the second component is not exceeded in the first shape, so that the spring properties cause the two-way actuator to return to the second shape upon cooling to the proper temperature.

In another embodiment of the present invention, a method is provided for using the two-way actuated composite material described above, comprising cooling the composite material below M_{f} of the first component, heating the composite material above A_{f} of the first component, and cooling the composite material below M_{f} of the first component.

### BRIEF DESCRIPTION OF THE DRAWINGS

FIGS. 1A and 1 show a prior art method of two-way actuation using nitinol.

FIGS. 2A and 2B show an embodiment of a composite material of the present invention at both a low temperature and a high temperature.

FIGS. 3A and 3B show embodiments of wires formed from composite materials in accordance with the present invention.

FIGS. 4A to 4C show embodiments of tubes formed from composite materials in accordance with the present invention.

FIG. 5 shows an embodiment of a strip with a rectangular cross-section, the strip being formed from composite material in accordance with the present invention.

FIGS. 6A and 6B show an embodiment of the material of the present invention formed into a spring.

FIGS. 7A and 713 show another embodiment of the material of the present invention formed into a spring.

FIGS. 8A and 8B show another embodiment of the material of the present invention formed into a spring.

FIGS. 9A and 9B show an embodiment of a wire formed from material of the present invention at a low temperature and a high temperature.

FIGS. 10A and 101B show a structure usable as a delivery device formed from material of the present invention.

FIGS. 11A and 11B show a structure usable as a gripping device formed from material of the present invention.

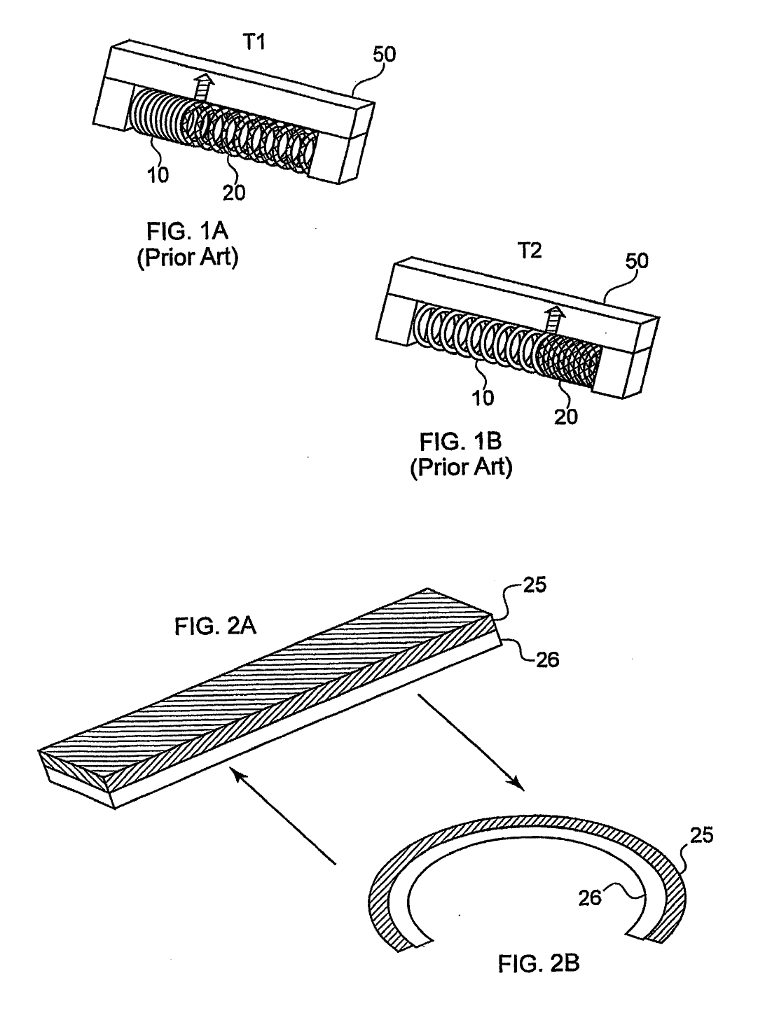

### DETAILED DESCRIPTION

The present invention provides a composite material that has two-way thermal actuation in the absence of an external bias. As one example, the composite material of the present invention may be used to reduce the profile of invasive medical device systems and improve the performance of these systems.

FIGS. 2A and 2B show an embodiment of a composite material according to the present invention. In FIG. 2A, a first component 26, which may be an SMA, is layered on a second component 25, which may be an elastic metal. This layering is not intended to be limiting, but may be reversed or include multiple layers.

In a, preferred embodiment, component 26 may be nitinol, and component 25 may be selected from biocompatible metals; stainless steels, such as 316; Co based alloys, such as MP35N or ELGILOY®; refractory metals, such as Ta, and refractory metal alloys; precious metals, such as Pt or Pd; titanium alloys, such as high elasticity beta Ti, such as FLEXFUM®; nickel superalloys; and combinations thereof. Specific stainless steel may also include austenitic or martensitic stainless steels, precipitation hardenable steels including 17-4PH, 15-4PH and 13-8Mo, or similar materials. Specific refractory metals and alloys may include Ta, Ta-10W, W, W—Re, Nb, Nb1Zr, C-103, Cb-752, FS-85, and T-111. Titanium alloys might be commercially pure, Ti6Al4V, Ti5Al2.5Sn, Beta C, Beta III or similar. In other preferred embodiments, component 26 is nitinol, and component 25 may be selected from high strength 300 Series stainless steel with an elastic recovery of approximately 1%, Beta C or Beta III titanium with an elastic recovery of approximately 1.5%, bulk metallic glass with an elastic recovery of approximately 2%, or High Elasticity Beta Ti; such as FLEXIUM™ with an elastic recovery of approximately 3-4%. The larger the elastic recovery of component 26, the better.

Two additional examples of shape memory alloy compositions include Ti—Pt—Ni with approximately 30% Pt and Ti—Pd—Ni with approximately 50% Pd. The Ti—Pt—Ni with approximately 30% Pt has an A_{f} of approximately 702° C. and an M_{f} of approximately 537° C., while the Ti—Pd—Ni with approximately 50% Pd has an A_{f} of approximately 591° C. and an M_{f} of approximately 550° C.

The components 25 and 26 may be joined together to form the layered material by a suitable process, including working and/or heating. Suitable metal working practices known in the art include drawing, swaging, rolling, forging, extrusion, pressing, and explosive bonding. In one example of a joining method, one component may be deposited or otherwise placed on or adjacent to the other component, the two components may be fused, for example with a hot isostatic press, and the two components may be rolled to a final thickness. A metallurgical bond is formed between the components, thereby forming the layered composite. A description of composite metal fabrication processing may be found in the ASM Handbook, Volume 2, Tenth Edition, pages 1043-1059.

To set the actuator shapes for the two way actuator shown in FIGS. 2A and 2B, the layered composite is formed into a first configuration (FIG. 2B) thereby storing elastic energy in component 25, the composite is held in the first configuration and heated so that the shape memory component 26 is in the relatively high-temperature austenite phase, and the composite is shaped into that first configuration as shown in FIG. 2B. The composite is then cooled below a transition temperature at which the shape memory component transforms to the relatively low-temperature martensite phase, and the stored elastic energy in component 25 forces the composite into a second configuration, as shown in FIG. 2A.

The layered composite shown in FIG. 2A is at a temperature T that is below M_{f} of component 26. FIG. 2B shows a bent shape achievable by heating the composite material to or above A_{f} of component 26. When heated to or above A_{f}, the SMA wants to change to its remembered shape, so the composite material takes the shape shown in FIG. 2B. To return the composite to its resting state or its initial shape as shown in FIG. 2A, the temperature of the composite is lowered. The elastic properties of the composite material cause the return to this shape.

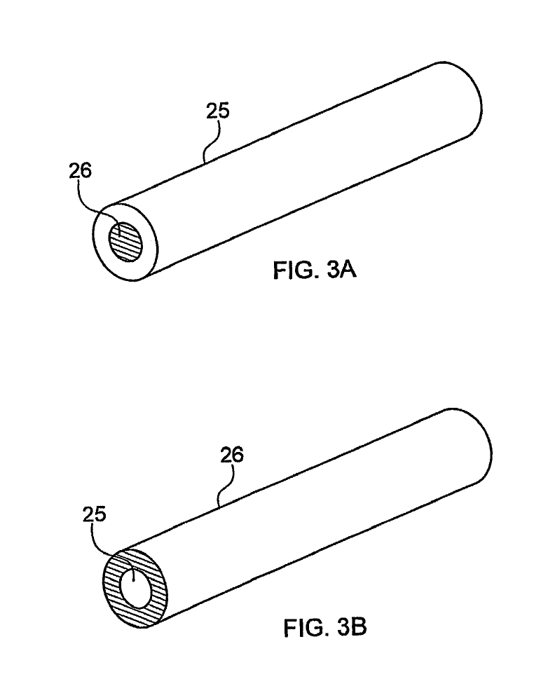

FIGS. 3A to 5 show additional embodiments of various composite material structures. FIG. 3A shows component 26 as a core of a wire with component 25 as cladding around the core. FIG. 3B shows the reverse structure, with component 25 as the core and component 26 as the cladding. These composite structures may be formed, for example, by placing a rod or tube within a tube and then drawing down to the illustrated diameter. It will be appreciated that through working and/or heat, a metallurgical bond may be formed between the two components, i.e., the core and the cladding, to form a composite structure.

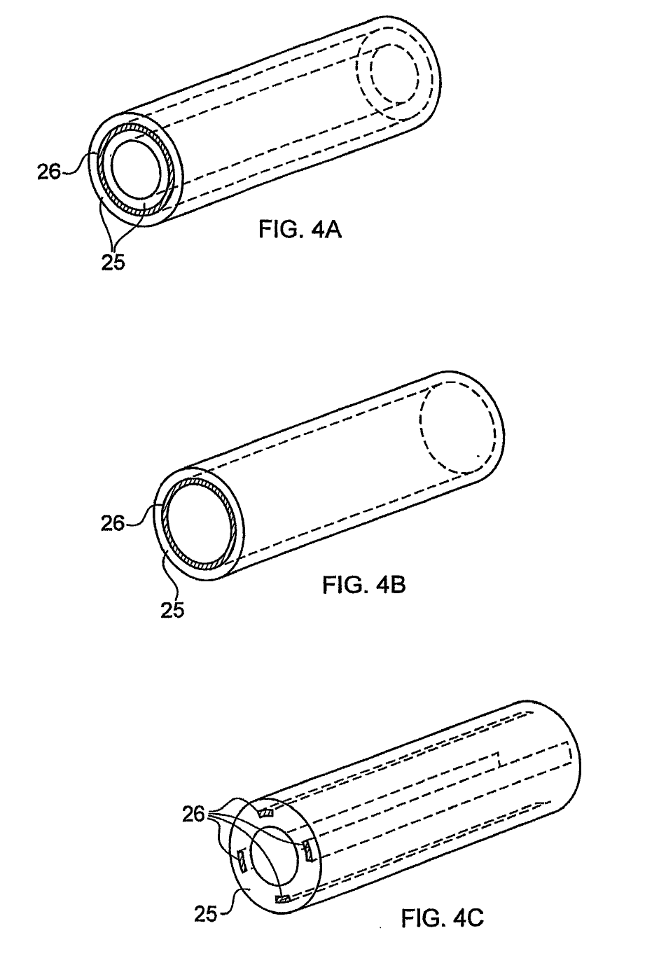

FIGS. 4A to 4C show examples of different ways of forming the composite material of the present invention into a tube. As shown in FIG. 4A, the tube may be predominantly one component, such as component 25 with an embedded ring of component 26. As shown in FIG. 4B, the tube may comprise an outer tube of component 25 and an inner tube of component 26. Alternatively, as shown in FIG. 4C, the tube may comprise discontinuous sections or strips of either component 25 or 26.

The structures of FIGS. 4A and 4B may be constructed, for example, by placing tubes within other tubes and drawing. The structure of FIG. 4C may be constructed, for example, by depositing stripes of component 26 on the outer surface of a tube of component 25, and then placing that structure inside a larger tube of component 25, and drawing. It will be appreciated that the material of the inner and outer tubes of component 25 may fuse between the areas of the stripes of material 26. Alternatively, the structures of FIGS. 4A-4C may be constructed by making a composite flat sheet as described above (depositing stripes in the case of FIG. 4C), and then rolling and joining to form a tube. It will be appreciated that with these techniques involving working and/or heating, a metallurgical bond is formed between components 25 and 26.

FIG. 5 shows another embodiment of the composite material, including a strip having a rectangular cross-section, where component 26 acts as a core and component 25 acts as cladding around the core. As will be appreciated, such a structure may be formed using techniques similar to those described above. Similar to FIG. 5, the composite material may also be in the form of a sheet.

Further methods for forming composite structures are disclosed in U.S. patent application Ser. No. 09/702,226, the disclosure of which is hereby incorporated herein by reference.

As one skilled in the art no doubt would understand, there are any number of possible configurations and structures that may be constructed to form the composite material of the present invention, including reversing the location and structure of the components shown.

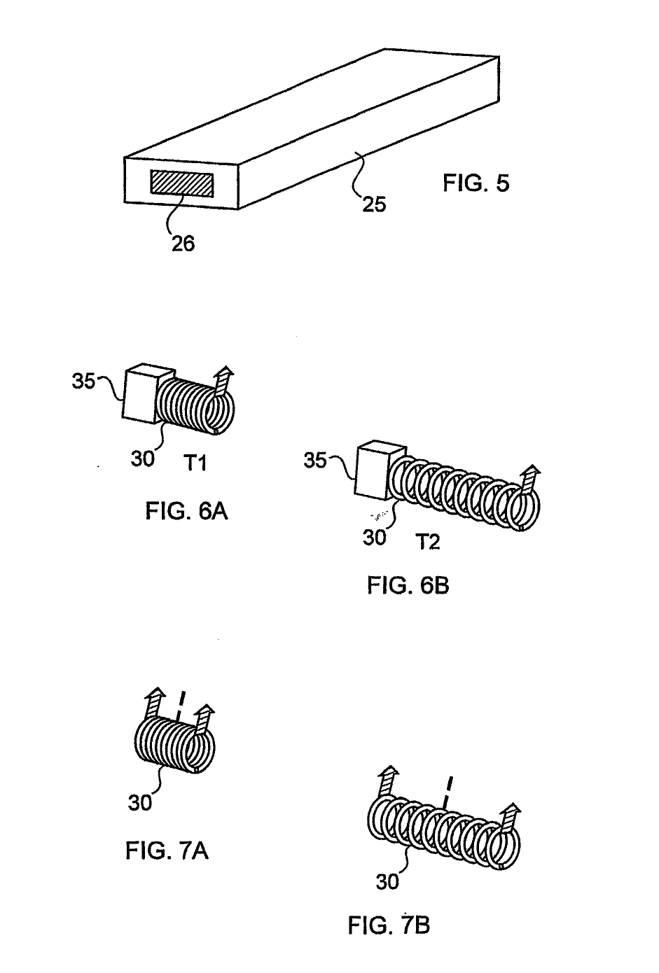

To illustrate the composite material's two-way actuation, FIGS. 6A to 8B show embodiments of the present invention formed into various types of springs. To form the springs shown, an embodiment of the composite material of the present invention is formed into a wire and then heat treated. For example, a composite structure as shown in FIGS. 3A and 3B may be used. To form the spring, a wire is wound around a mandrel to form a coil or bias spring, and then heat treated at a suitable temperature for a suitable period of time, for example, heated to between approximately 350° C. to 650° C. for approximately 2 to 30 minutes (or longer), to set the spring shape. As an example, the heat treating range is approximately between 450° C. and 550° for between 5 and 15 minutes.

In FIGS. 6A and 6B, a spring 30 formed from the composite material of the present invention is affixed to a structure 35. This embodiment of the present invention illustrates one possible direction of movement for an actuator. In FIGS. 6A and 6B, the spring 30 may move laterally in a single direction by expanding and contracting. For example, the spring 30 contracts or relaxes when cooled to or below the M_{f} of component 26, and it expands when the spring 30 is heated to or above A_{f} of component 26. One use for this configuration may be to reduce the size of a two way thermal actuator.

In FIGS. 7A and 7B, a spring 30 formed from a composite material of the present invention is illustrated moving laterally in two directions. In FIGS. 7A and 7B, no external fixation is used, and the spring 30 again expands and contracts based on the temperature applied. Uses for this embodiment may be to engage and release pins in a delivery system or to act as a spring trigger.

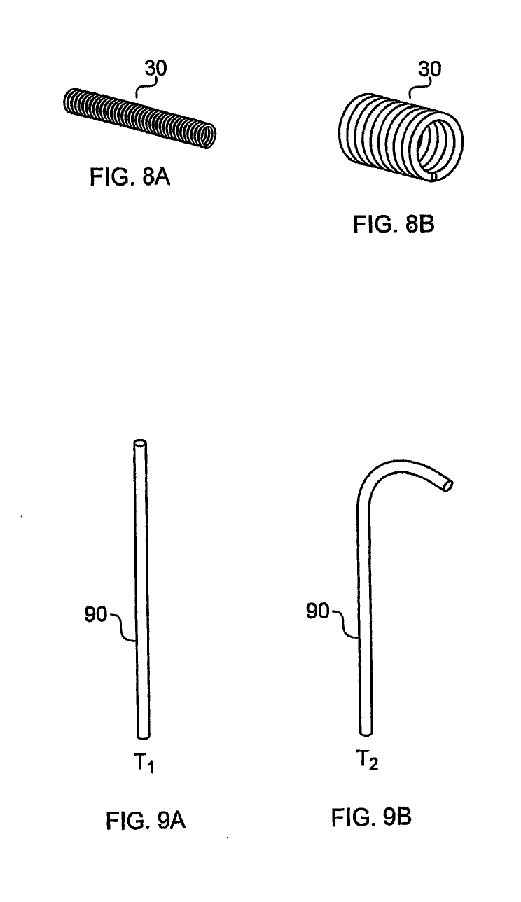

In FIGS. 8A and 8B, a tight spring 30 is formed, which expands to a larger diameter formation as temperature is applied. This configuration may be used to provide access to an area when the bias spring is enlarged and to block access to the same area by shrinking the bias spring.

FIGS. 9A-11B show examples of different geometries the composite material of the present invention may take. For example, FIGS. 9A-B show a wire 90 formed from an embodiment of the composite material of the present invention. At T₁ (equal to or less than M_{f}) the wire 90 is straight; however at T₂ (equal to or more than A_{f}), the wire 90 bends. A use for the wire shown in FIGS. 9A and 9B may be as a shapeable guidewire or catheter.

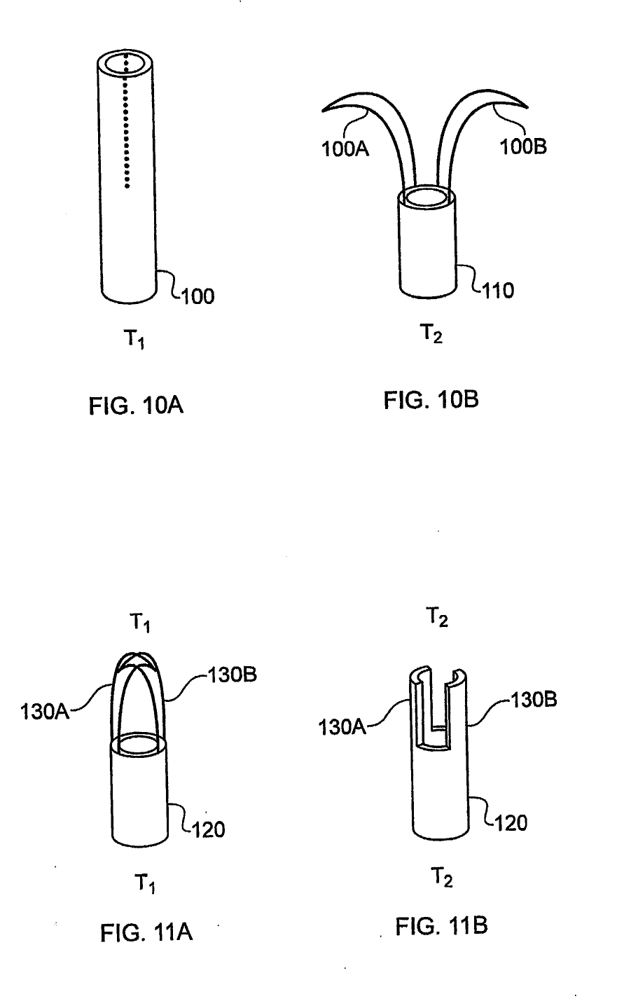

In FIG. 10A, a tubular structure 100 formed from an embodiment of the composite material of the present invention has a seam running from one end. The tube 100 is shown in FIG. 10A at T₁ (equal to or less than M_{f}). At T₂ (equal to or more than A_{f}), as shown in FIG. 10B, the portion of the tube 100 of FIG. 10A that had the seam has opened into two separate portions 100A and 100B. One use for this structure may be as a delivery system, where the structure shown in FIG. 10B is used to release an item.

Similar to FIGS. 10A and 10B, FIGS. 11A and 11B show a structure that may be used as a reversible grasper or ablation grasper. In FIG. 11A, a tubular structure 120 having finger portions 130A and 130B is shown at T₁ (equal to or less than M_{f}). In FIG. 11B, the structure changes to an open configuration at T₂ (equal to or more than A_{f}). Alternatively, the reverse motion, i.e., moving from an open position as shown in FIG. 11B at T₁ (equal to or less than M_{f}) to closure as shown in FIG. 11A at T₂ (equal to or more than A_{f}), can also be obtained through alternative positioning during shape setting. Closure at elevated temperatures could be a useful feature in certain applications.

Many additional geometries are possible with the composite materials of the present invention. For example, the composite material may be formed into a cantilever beam, a belleville washer, a thin film membrane, a linear wire or rod, a helical spring, or a tension spring.

To use the composite material of the present invention, a two-way actuation cycle is used. In a preferred embodiment of the present invention, a body temperature/ice water actuation cycle is illustrated. In this method a composite material of the present invention is formed using Nitinol with an A_{f} of approximately 35° C. and a M_{f} of approximately 0° C., and one of the following materials: stainless steel, a cobalt alloy, tantalum, platinum, palladium or high elasticity titanium (FLEXIUM®). The composite material is then formed into a wire, strip, or tube. Thermal shaping is next performed, where the composite material structure is heat treated at a suitable temperature for a suitable period of time (for example, the temperatures and times stated above) and held in a particular shape, such as the bent structure shown in FIG. 2B. When the composite material is bent, the bend strain can be within the elastic range for the non-nitinol component. Following thermal shaping, the composite material may then be cooled below M_{f}, which will soften the nitinol and allow for elastic recovery of the non-nitinol component, and thus straighten the composite material. The composite material may then be heated above A_{f} in order to activate the memorized configuration. To release or recover from the memorized configuration, the composite material may be cooled to below M_{f}. M_{f} and A_{f} may be between −200° C. to 170° C. These heating and cooling cycles may be repeated as often as necessary.

In another preferred embodiment of the present invention, a reversible two-way actuation cycle may use an elevated temperature and body temperature as the cycling temperatures. For example, a composite material structure as described above may be formed using thermal shaping. However, in this embodiment, the nitinol A_{f} temperature is approximately 100° C. and the M_{f} is approximately 40° C. As described above, the temperature cycling may go from cooling the composite material to heating the composite material as many times as required.

The thermal fluctuations used in these two embodiments may be any type of thermal cycling, such as different temperature fluids, electric resistance heating, induction heating, and conduction heating, in the body or otherwise. In addition, the range of thermal fluctuations may extend beyond the functional temperature range of binary nitinol. For example, if additional alloying elements are used to increase phase transformation temperature, then the upper temperature may be as high as 700° C.

While the present invention has been described with reference to what are presently considered to be preferred embodiments thereof, it is to be understood that the present invention is not limited to the disclosed embodiments or constructions. On the contrary, the present invention is intended to cover various modifications and equivalent arrangements. In addition, while the various elements of the disclosed invention are described and/or shown in various combinations and configurations, which are exemplary, other combinations and configurations, including more, less or only a single embodiment, are also within the spirit and scope of the present invention.

I claim:

1. An article of manufacture, comprising:
a hollow tube comprising an elastic metal; and
a plurality of discrete elements disposed within the wall of the hollow tube such that each discrete element is not in contact with another discrete element;
wherein the discrete elements comprise a shape memory alloy.

2. The article of claim 1, wherein each of the discrete elements are in the form of a strip that is longitudinally disposed within the wall of the hollow tube.

3. The article of claim 1, wherein the plurality of discrete elements are metallurgically bonded to the hollow tube.

4. The article of claim 1, wherein the article has a first shape at a temperature equal to or above a temperature A_{f} at which transformation of the shape memory alloy from martensite to austenite is complete;
wherein the article has a second shape at a temperature equal to or below a temperature M_{f} at which transformation of the shape memory alloy from austenite to martensite is complete;
wherein at a temperature equal to or above A_{f}, the discrete elements exert a force against the hollow tube to elastically deform the hollow tube so that the article assumes the first shape; and
wherein at a temperature equal to or below M_{f}, the force from the discrete elements is at least partially released so that the article assumes the second shape.

5. The article of claim 1, wherein the shape memory alloy is nitinol.

6. The article of claim 1, wherein the elastic metal is selected from the group consisting of a second shape memory alloy, stainless steel, cobalt alloy, refractory metal or alloy, precious metal, titanium alloy, nickel superalloy, and combinations thereof.

7. The article of claim 1, wherein the elastic metal is selected from the group consisting of nitinol, stainless steel 316, austenitic stainless steels, precipitation hardenable steels including 17-4PH, 15-4PH and 13-8Mo, MP35N, ELGILOY, Ta, Ta-10W, W, W—Re, Nb, Nb1Zr, C-103, Cb-752, FS-85, T-111, Pt, Pd, beta Ti, Ti6Al4V, Ti5Al2.5Sn, Beta C, Beta III, and FLEXIUM.
